(19) United States
(12) Patent Application Publication
(10) Pub. No.: US 2020/0200378 A1
(43) Pub. Date: Jun. 25, 2020

(54) High Bay Lighting Fixture

(71) Applicant: Eaton Intelligent Power Limited, Dublin (IE)

(72) Inventors: Audie T. Stokes, Tyrone, GA (US); James H. Blessitt, Peachtree City, GA (US)

(21) Appl. No.: 16/719,567

(22) Filed: Dec. 18, 2019

Related U.S. Application Data
(60) Provisional application No. 62/783,955, filed on Dec. 21, 2018.

(51) Int. Cl. F21V 29/74; F21V 23/00; F21S 8/06; F21V 21/03

(52) U.S. Cl. CPC F21V 29/745; F21V 21/03; F21S 8/063; F21V 23/002

(57) ABSTRACT

A high bay lighting fixture includes an electronics housing and a light module that includes a light source that emits a light. The high bay lighting fixture further includes a tubular connector. The electronics housing is attached to the tubular connector at a first end of the tubular connector, and the light module is attached to the tubular connector at a second end of the tubular connector separated from the electronics housing by the tubular connector. The tubular connector provides a wireway for routing an electrical wire between the electronics housing and the light module.

### CROSS REFERENCE TO RELATED APPLICATIONS

The present application claims priority under 35 U.S.C. Section 119(e) to U.S. Provisional Patent Application No. 62/783,955, filed Dec. 21, 2018 and titled “High Bay Lighting Fixture,” the entire content of which is incorporated herein by reference.

### TECHNICAL FIELD

The present disclosure relates generally to lighting fixtures, and more particularly to light fixtures with modular components and thermal management features.

### BACKGROUND

Traditional high bay light fixtures have two large spaces. One of the large spaces is formed by a reflector/refractor encasing the light source of the light fixture, and the other large space is in an electronics compartment encasing the components that control the light source. Aside from the overall large space taken up by these spaces, the electronics housing is typically situated directly above the light source. In such light fixtures, the electronic components in the electronic housing are exposed to heat generated by the electronic components themselves and to heat generated by the light sources. For high bay lighting fixtures that are IP65 rated for protection against dust and water, heat generated by the light sources can reduce the effective life of the lighting fixtures. Even with solid state light sources, the thermal loads generated by the light sources reduce the effective life of the electronics, and in turn, the effective life of the light fixtures. Thus, a high bay lighting fixture that reduces the damaging effects of heat generated by the light source of the lighting fixture may extend the effective life of the electronics and the lighting fixture.

### SUMMARY

The present disclosure relates generally to lighting fixtures, and more particularly to light fixtures with modular components and thermal management features. In an example embodiment, a high bay lighting fixture includes an electronics housing and a light module that includes a light source that emits a light. The high bay lighting fixture further includes a tubular connector. The electronics housing is attached to the tubular connector at a first end of the tubular connector, and the light module is attached to the tubular connector at a second end of the tubular connector separated from the electronics housing by the tubular connector. The tubular connector provides a wireway for routing an electrical wire between the electronics housing and the light module. The tubular connector is designed for attachment to multiple light modules that are configured to emit lights having different lumens from each other.

In another example embodiment, a high bay lighting fixture component assembly includes an electronics housing, a light module comprising a light source that emits a light, and a tubular connector. The electronics housing is one of multiple electronics housings that are designed for attachment to the tubular connector at a first end of the tubular connector, and the light module is one of multiple light modules designed for attachment to the tubular connector at a second end of the tubular connector. Each light module of the multiple light modules is configured to emit a light having lumens output that is different from the lumens output of lights emitted by other light modules of the multiple light modules.

In another example embodiment, a method of assembling a suspended lighting fixture includes providing a tubular connector and attaching the electronics housing to a first end portion of the tubular connector. The electronics housing is one of multiple electronics housings that are designed for attachment to the first end portion of the tubular connector. The method further includes attaching a light module to a second end portion of the tubular connector. The light module is one of multiple light modules that are designed for attachment to the second end portion of the tubular connector. The tubular connector provides a separation between the electronics housing and the light module.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIG. 1 is a side view of a high bay lighting fixture according to an example embodiment;

FIG. 2 is a top perspective view of the lighting fixture of FIG. 1 according to an example embodiment;

FIG. 3 is a cross-sectional view of the lighting fixture of FIG. 1 according to an example embodiment;

FIG. 4 is another cross-sectional view of the lighting fixture of FIG. 1 according to an example embodiment;

FIG. 5 is another top perspective view of the lighting fixture of FIG. 1 according to an example embodiment;

FIG. 6 is a bottom view of the lighting fixture of FIG. 1 according to an example embodiment;

FIG. 7 is another bottom view of the lighting fixture of FIG. 1 according to an example embodiment;

FIG. 8 is a bottom perspective view of the lighting fixture of FIG. 1 according to an example embodiment;

FIG. 9 is a top perspective view of a high bay lighting fixture according to another example embodiment;

FIG. 10 is a bottom view of the high bay lighting fixture of FIG. 9 according to an example embodiment;

FIG. 11 is a bottom perspective view of a high bay lighting fixture according to another example embodiment;

FIG. 12 is a bottom perspective view of a high bay lighting fixture according to another example embodiment;

FIG. 13 is a bottom perspective view of a high bay lighting fixture according to another example embodiment;

FIG. 14 is a bottom perspective view of a high bay lighting fixture according to another example embodiment; and

FIG. 15 is closeup view of an attachment mechanism of light modules of the high bay lighting fixture of FIGS. 13 and 15 according to another example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in multiple drawings designate like or corresponding but not necessarily identical elements.

### DETAILED DESCRIPTION OF EXAMPLE EMBODIMENTS

In the following paragraphs, particular embodiments will be described in further detail by way of example with reference to the figures. In the description, well known components, methods, and/or processing techniques are omitted or briefly described. Furthermore, reference to various feature(s) of the embodiments is not to suggest that all embodiments must include the referenced feature(s).

In some example embodiments, a high bay lighting fixture includes several components including a light module, an electronics housing, and a hollow tubular connector extending between the light module and the electronics housing. Wiring between the light module and electronics housing may be routed through the tubular connector. The light module may include a heat sink and light sources that are attached on a side of the heat sink facing away from the electronics housing, where the tubular connector provides an adequate separation between the heat sink and the electronics housing to allow heat dissipation in a manner that has minimal impact on the electronics housed in the electronics housing.

In some example embodiments, the components of the high bay lighting fixture may be changeable components, where one of multiple separate die cast heat sinks and one of multiple electronics housings may be used along with or without the tubular connector. For example, each light module may include a heat sink, light sources including printed circuit boards with light emitting diodes (LEDs), lenses covering the light sources, and an optional sensor module. Various light distributions are available with different lenses, and the lenses may provide water ingress protection (IP) for the light module. Each of the electronics housings may house various electrical components including one or more drivers and provide the main mounting means of the lighting fixture. For example, one electronics housing may be an IP65 rated, die cast aluminum housing, and another electronics housing may be a wet location rated sheet metal housing.

In some alternative embodiments, the light module may be a modular structure. For example, a base light module may include light sources covered by lenses and attached to a heat sink. For example, the base light module may be approximately 12″ diameter and may provide a light at relatively lower lumen ranges. For increased lumen output, a secondary light module may be attached to the outer perimeter of the base light module, where the secondary light module includes light sources that are covered by lenses and attached to a heat sink. For example, the base light module and the secondary light module may be ring-shaped, where the base light module may fit within the secondary light module. The combination of the base light module and the secondary light module may provide midrange lumen levels. To provide lumen levels in a higher range, a tertiary light module may be attached to the secondary light module that is attached to the base light module. For example, the tertiary light module may be ring-shaped and may be attached to the outer perimeter of the secondary light module. The tertiary light module may include light sources that are covered by lenses and that are attached to a heat sink. Each of the light modules are electrically connected to one or more drivers that are in the electronics housing that may be separated from the light modules by one or more hollow tubular connectors. In some example embodiments, the secondary and the tertiary light modules may be added to base light module at the factory/assembly plant based on the need for a particular lighting fixture. Cost reduction and volume scalability may be achieved by using common components for a base lighting fixture and adding the secondary and tertiary light modules as needed to achieve the desired lumen output.

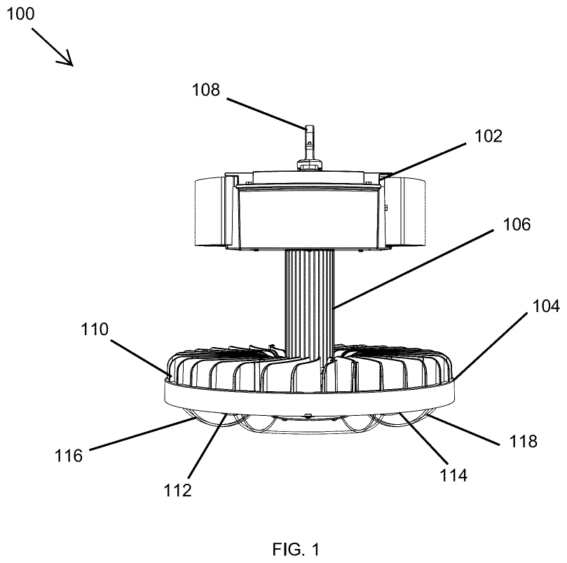

Turning now to the drawings, FIG. 1 is a side view of a high bay lighting fixture 100 according to an example embodiment. In some example embodiments, the lighting fixture 100 includes an electronics housing 102, a light module 104, and a tubular connector 106. The lighting fixture 100 may also include an attachment structure 108 that is attached to the electronics housing 102. The attachment structure 108 can be used to mount the lighting fixture 100, for example, to a ceiling. The electronics housing 102 may be attached to the tubular connector 106 at one end of the tubular connector 106, and the light module 104 may be attached to the tubular connector 106 at an opposite end of the tubular connector 106. The tubular connector 106 may be hollow such that one or more electrical wires can be routed between the electronics housing 102 and the light module 104. For example, the electronics housing 102 may provide a compartment for electrical components of the lighting fixture 100 such as a driver that provides power to the light sources of the lighting fixture 100.

In some example embodiments, the light module 104 provides an illumination light. For example, the light module 104 may include a heat sink 110 and light sources such as light sources 112, 114 that emit the illumination light. The light sources may include printed circuit boards (PCBs) that have respective light emitting diodes (LEDs) attached thereon. The number and type of LEDs included with each PCB may depend on the desired lumens of the overall light provided by the lighting fixture 100. The light sources may be attached to the heat sink 110. The light module 104 may also include one or more lenses, such as the lenses 116, 118 covering the light sources 112, 114, that provide a protection to the light sources 112, 114 against water and dust. The light sources 112, 114 may be positioned on the side of the heat sink 110 facing away from the electronics housing 102.

In some example embodiments, the heat sink 110 can serve to dissipate heat produced by the light sources. The tubular connector 106 may provide adequate separation between the heat sink 110 and the electronics housing 102 such that the electrical components that are contained in the electronics housing 102 are not affected by the dissipated heat.

In some example embodiments, the lighting fixture 100 includes one or more reflectors positioned to reflect light provided by the light sources. For example, the one or more reflectors may be attached to the heat sink 110 using one or more fasteners or other means as may be contemplated by those of ordinary skill in the art with the benefit of this disclosure. In some example embodiments, the lighting fixture 100 includes one or more wireguards that are positioned to protect the one or more lenses, such as the lenses 116, 118. For example, the one or more wireguards may be attached to the heat sink 110 using one or more fasteners or other means as may be contemplated by those of ordinary skill in the art with the benefit of this disclosure.

In some example embodiments, the tubular connector 106 may be attached to the electronics housing 102 using one or more fasteners that can be readily removed to detach the electronics housing 102 from the tubular connector 106 and attach a different electronics housing to the tubular connector 106. For example, one or more screws may be used to attach the electronics housing 102 to the tubular connector 106.

In some example embodiments, the tubular connector 106 may be attached to the light module 104 using one or more fasteners that can be readily removed to detach the light module 104 from the tubular connector 106 and attach a different light module to the tubular connector 106. In particular, the tubular connector 106 may be attached to the heat sink 110 using one or more fasteners. For example, one or more screws may be used to attach the heat sink 110 to the tubular connector 106.

In some example embodiments, the tubular connector 106 may be attached to another electronics housing instead of the electronics housing 102. For example, the tubular connector 106 may be attached to a larger or smaller electronics housing in the same manner as the tubular connector 106 is attached to the electronics housing 102. In some example embodiments, the tubular connector 106 may be attached to another light module instead of the light module 104. For example, the tubular connector 106 may be attached to another light module that can provide a light having more lumens than the light provided by the light module 104. The tubular connector 106 may be attached to another light module in the same manner as the tubular connector 106 is attached to the light module 104.

In some example embodiments, the electronics housing 102 and the heat sink 110 may be a die cast aluminum or another metal. In some example embodiments, the tubular connector 106 may be extruded aluminum or another metal.

In some alternative embodiments, the electronics housing 102, the light module 104, and the tubular connector 106 may have different shapes than shown in FIG. 1 without departing from the scope of this disclosure. In some alternative embodiments, the lighting fixture 100 may include multiple tubular connectors instead of the tubular connector 106, where the multiple tubular connectors extend between the electronics housing 102 and the light module 104 separating the light module 104 from the electronics housing 102.

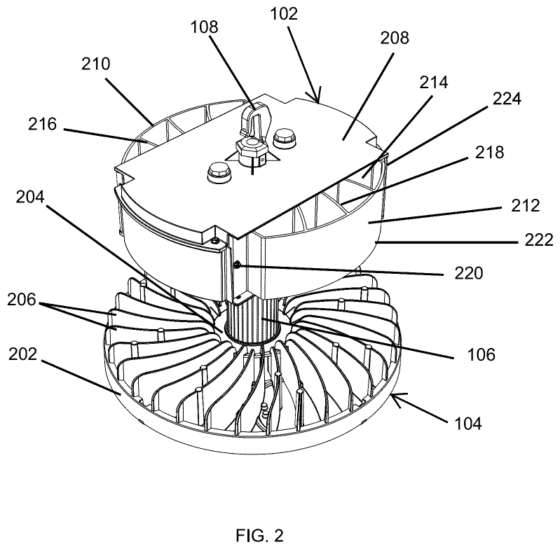

FIG. 2 is a top perspective view of the lighting fixture 100 of FIG. 1 according to an example embodiment. Referring to FIGS. 1 and 2, in some example embodiments, the heat sink 110 may include an outer frame 202, an inner frame 204, and fins, such as the fins 206, extending between the outer frame 202 and the inner frame 204. For example, the fins may be on the side of the heat sink 110 facing the electronics housing 102 and on the opposite side from the light sources. The fins may serve to dissipate heat generated by light sources away from the light module 104.

In some example embodiments, the electronics housing 102 may include a back cover 208 and side doors 210, 212. For example, the side door 212 may include an inner wall 214 that encloses the cavity of the heat sink 110, where fins 218 extend out from the inner wall 214 to an outer wall 222 of the side door 212. The side door 210 may also include fins 216 that extend between an inner wall enclosing the cavity of the electronics housing 102 and an outer wall of the side door 210. The fins 216, 218 serve to dissipate heat generated by electrical components contained in the cavity of the electronics housing 102.

In some example embodiments, the side door 212 may be opened by removing or loosening a fastener 220 and rotating the side door about a hinged end 224. To illustrate, the side door 212 may be hinged at the hinged end such that the side door 212 can be rotated to open and close the side door 212. The side door 212 may be secured back to the rest of the electronics housing 102 using the fastener 220. The side door 212 provides access to the inside of the electronics housing 102 to repair, replace, add or remove components, to make electrical connections, etc. The side door 212 provides access to the inside of the electronics housing 102 without the need to remove the lighting fixture 100 that may be installed and/or without the need to remove the entire electronics housing 102. In some example embodiments, the side door 210 may also be opened and closed in a similar manner as the side door 212.

In some example embodiments, the mounting structure 108 may be attached to the back cover 208. For example, the mounting structure 108 may be hook-shaped such that the mounting structure 108 can be hooked onto another mounting structure to attach the lighting fixture 100, for example, to a ceiling. The mounting structure 108 may have a threaded end that is inserted into a mounting hole in the back cover 208 of the electronics housing 102. In some example embodiments, the mounting structure 108 allows the lighting fixture 100 to be suspended from a structure, such as a ceiling.

In some example embodiments, the side doors 210, 212 may be extruded aluminum or another metal, and the heat sink 110 and the rest of the electronics housing 102 may be die cast aluminum or another metal.

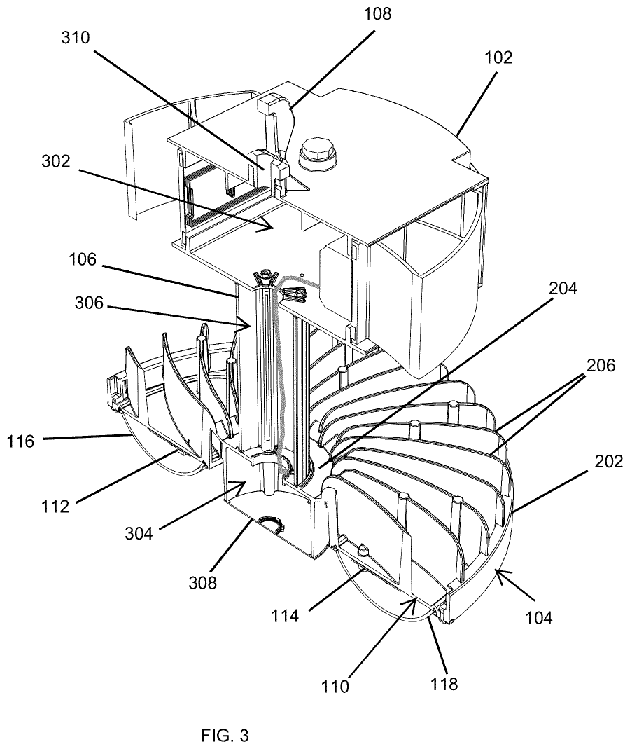

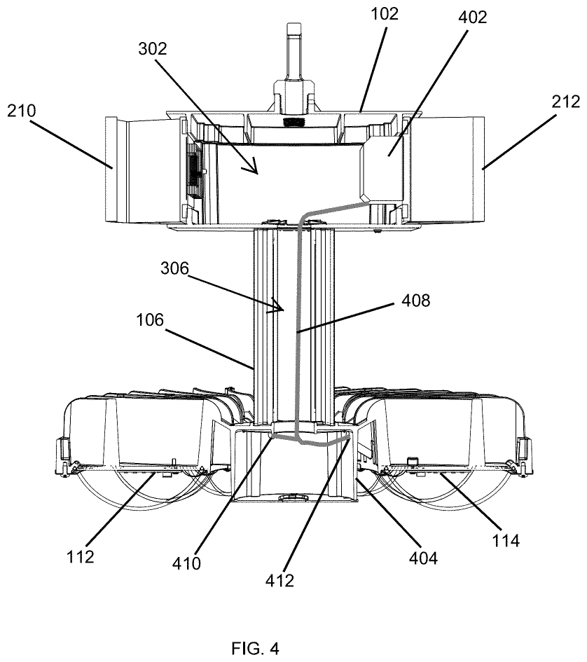

FIG. 3 is a cross-sectional view of the lighting fixture 100 of FIG. 1 according to an example embodiment, and FIG. 4 is another cross-sectional view of the lighting fixture of FIG. 1 according to an example embodiment. Referring to FIGS. 1-4, in some example embodiments, the lighting fixture 100 includes a driver 402 that is located in a cavity 302 of the electronics housing 102. An electrical cable 408 that is connected to the driver 402 may be routed through a wireway 306 of the tubular connector 106 to the light module 104. For example, the electronics housing 102 may include an opening that is aligned with the wireway 306 of the of the tubular connector 106, and the heat sink 110 may include an opening that is also aligned with the wireway 306 of the of the tubular connector 106.

To illustrate, the electrical cable 408 may be routed to the light sources of the light module 104, such as the light sources 112, 114, through a compartment 304 bound by the inner frame 204 of the heat sink 110. For example, the driver 402 may provide electrical power to the light sources via the electrical cable 408. A wall 404 of the inner frame 204 may include routing holes, such as routing holes 410, 412, that are used to route electrical wires of the electrical cable 408 or connected to the electrical cable 408 to the light sources of the light module 104. For example, the routing holes may lead into respective wireways that are used to route the wires to the light sources of the light module 104. A bottom cover 308 may cover the compartment 304 such that the wires are not viewable from below the lighting fixture 100.

In some example embodiments, the mounting structure 108 may include a wireway 310 for routing an electrical cable into the cavity 302 of the electronics housing 102. For example, an electrical cable that is used to provide AC power to the driver 402 may be routed into the cavity 302 through the route 310.

In some alternative embodiments, the lighting fixture 100 may include more than one driver that are positioned in the electronics housing 102. In some example embodiments, the lighting fixture 100 may include other components that are located in the electronics housing 102.

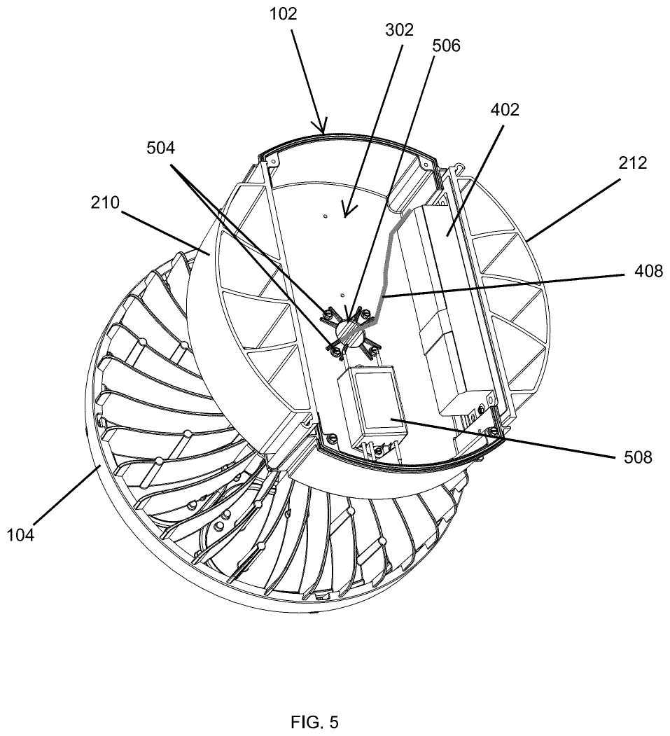

FIG. 5 is another top perspective view of the lighting fixture of FIG. 1 according to an example embodiment. Referring to FIGS. 1-5, in some example embodiments, the electronics housing 102 may be removably attached to the tubular connector 106 using fasteners, such as fasteners 504. For example, the fasteners may be threaded screws that are inserted into corresponding holes in the bottom wall of the electronics housing 102 and in the tubular connector 106. In some example embodiments, the electronics housing 102 may be replaced by another electronics housing of the same or different size/type by removing the fasteners, detaching the electronics housing 102, and attaching the other electronics housing.

In some example embodiments, instead of the electronics housing 102, a different electronics housing can be attached to the tubular connector 106 using the same fasteners, such as fasteners 504, for example at the factory/assembly plant. To illustrate, the other electronics housing may have holes that are located in the same configuration as the holes in the electronics housing 102 for attaching to the tubular connector 106 using the fasteners. For example, the electronics housing 102 may be an IP65 rated, die cast aluminum housing, and the other electronics housing may be a wet location rated sheet metal housing. In general, a lighting fixture component assembly may include the electronics housing 102, the light module 104, and the tubular connector 106, where the electronics housing 102 may be one of multiple electronics housings that can be attached to the tubular connector 106 at one end portion of the tubular connector 106, and where the light module 104 may be one of multiple light modules that can be attached to the tubular connector 106 at an opposite end portion of the tubular connector 106.

In some example embodiments, the electrical cable 408 may be routed from the driver 402 into the tubular connector 106 through an opening 506 in a bottom cover of the electronics housing 102. In some example embodiments, the lighting fixture 100 may include other electrical components, such as a surge protector 508 or a control module, and electrical wires from the other electrical components may also be routed to the light module 104 through the opening 506 and the tubular connector 106.

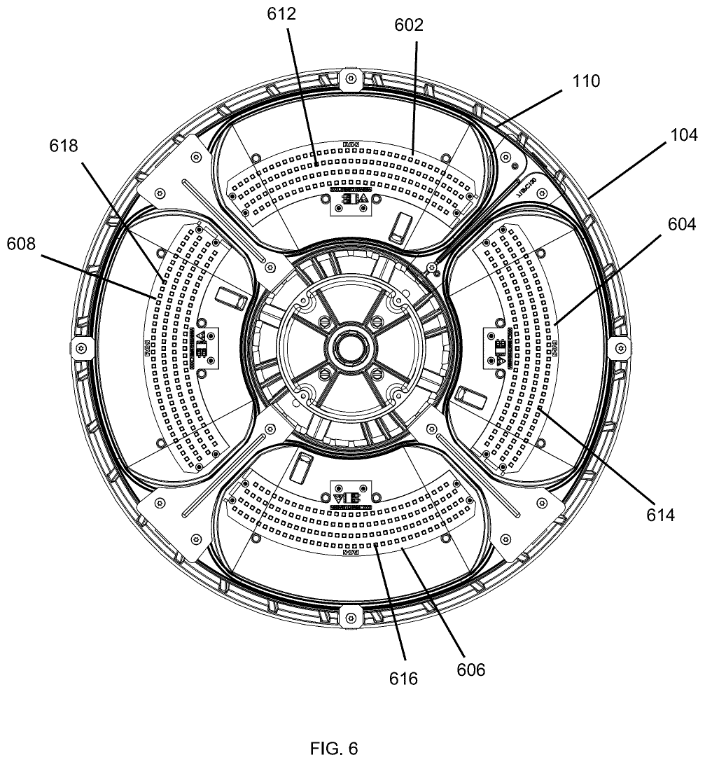

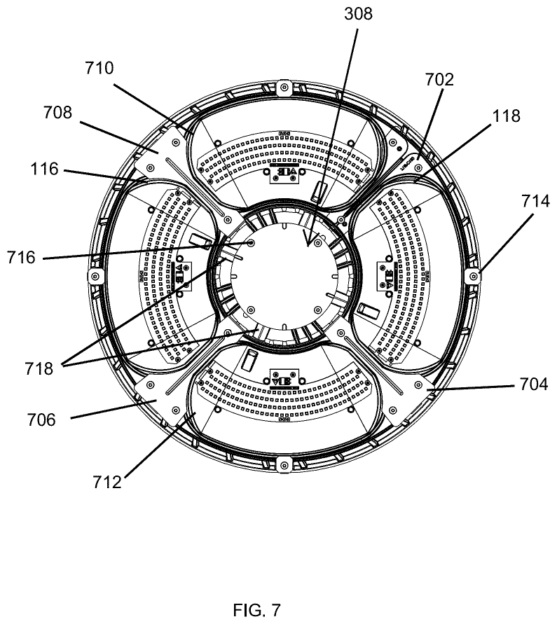

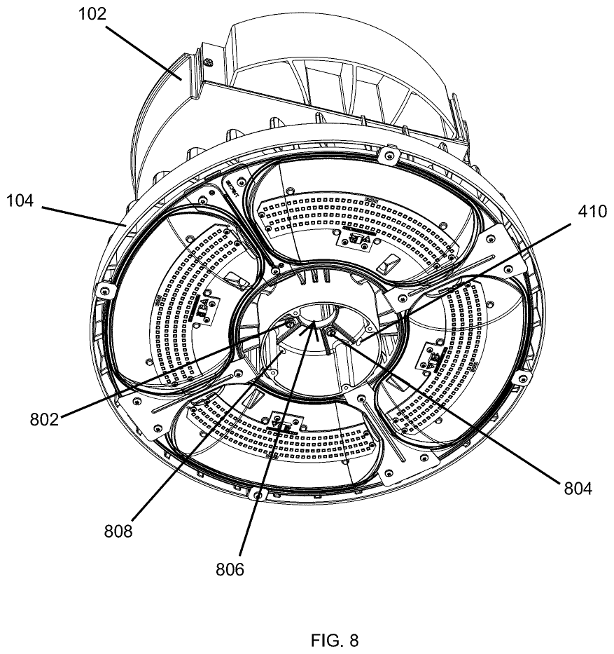

FIG. 6 is a bottom view of the lighting fixture of FIG. 1 according to an example embodiment, FIG. 7 is another bottom view of the lighting fixture of FIG. 1 according to an example embodiment, and FIG. 8 is a bottom perspective view of the lighting fixture of FIG. 1 according to an example embodiment. Referring to FIGS. 1-8, in some example embodiments, the light module 104 includes light sources 602, 604, 606, 608. The light source 602 may include LEDs 612 that are attached to the PCB of the light source 602. The light source 604 may include LEDs 614 that are attached to the PCB of the light source 604. The light source 606 may include LEDs 616 that are attached to the PCB of the light source 606. The light source 608 may include LEDs 618 that are attached to the PCB of the light source 608. The number and type of LEDs that are attached to the heat sink 110 may be different depending on the desired lumen of the light provided by the lighting fixture 100. In some example embodiments, the light module 104 may be larger in size to accommodate light sources that provide higher lumen lights.

In some example embodiments, brackets 702, 704, 706, and 708 may be attached to the heat sink 110 and may be used to securely attach the lenses 116, 118, 710, 712 to the heat sink 110. In some example embodiments, brackets, such as the bracket 714, may also help to securely attach the lenses 116, 118, 710, 712 to the heat sink 110.

In some example embodiments, the bottom cover 308 is attached to the heat sink 110 using one or more fasteners 716. The bottom cover 308 can be removed to access the compartment 304, where electrical wires may be routed to the different light sources through routing holes, such as the routing holes 410, 412, 808. The electrical wires may be routed to the light sources from the compartment 304 via wireways, such as the wireways 718. The electrical cable 408 that is connected to the driver 402 is routed through the tubular connector 106 into the compartment 304 via an opening 806 of the heat sink 110 that is aligned with the wireway 306 of the tubular connector 106.

In some example embodiments, the bottom cover 308 may be removed and a device, such as a sensor or another an internet of things (IoT) device, may be attached to the heat sink 110. For example, the device may be connected to one or more electrical components (e.g., a power source and/or a communication unit) in the cavity of the electronics housing 102 via the electrical cable 408 or another electrical connection.

In some example embodiments, one or more fasteners 802, 804 may be used to removably attach the light module 104 to the tubular connector 106. For example, the fasteners 802, 804 may be threaded screws that are inserted into corresponding holes in the heat sink 110 and in the tubular connector 106. In some example embodiments, the light module 104 may be replaced by another light module of the same or different size/type by removing the fasteners 802, 804, detaching the light module 104 from the tubular connector 106, and attaching the other light module to the tubular connector 106. In some example embodiments, instead of the light module 104, a different light module 104 that, for example, provides a higher or lower lumen light can be attached to the tubular connector 106 using the fasteners 802, 804, for example at a factory/assembly plant during assembly of the lighting fixture 100.

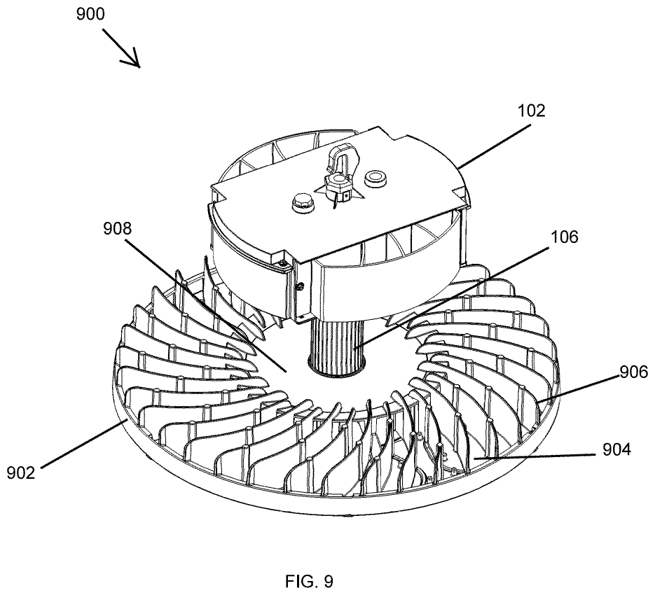

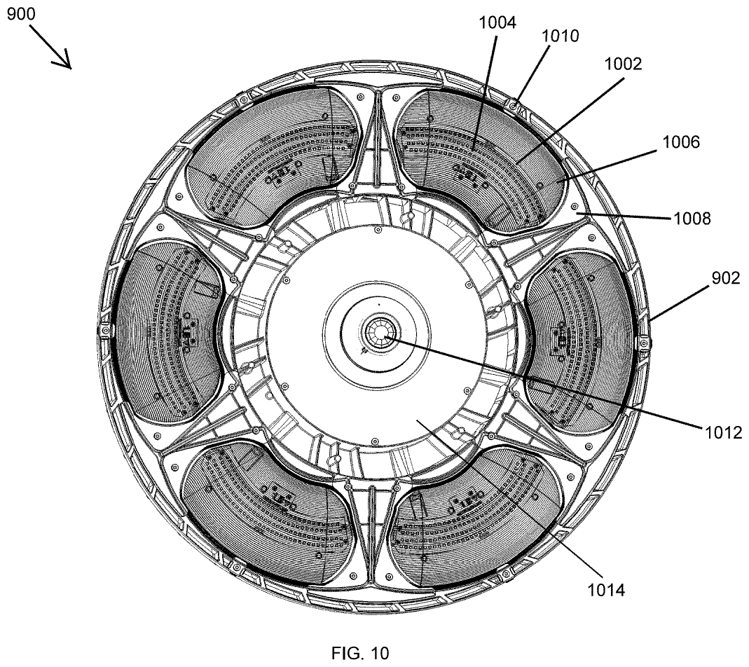

FIG. 9 is a bottom perspective view of a high bay lighting fixture 900 according to another example embodiment, and FIG. 10 is a bottom view of the high bay lighting fixture of FIG. 9 according to an example embodiment. Referring to FIGS. 1 and 9, in some example embodiments, the lighting fixture 900 includes the housing 102, the tubular connector 106, and a light module 902. The light module 902 may include a heat sink 904 that has fins such as a fin 906. The tubular connector 106 may be attached an inner frame 908 of the heat sink 904 in a similar manner as described with respect to the tubular connector 106 and the inner frame 204 of the lighting fixture 100.

In some example embodiments, the lighting fixture 900 is substantially similar to the lighting fixture 100. In contrast to the lighting fixture 100, the light module 902 is relatively larger than the light module 104 of the lighting fixture 100. For example, the light module 902 may provide a light with a higher lumen level than the light provided by the light module 104. To illustrate, the light module 902 may include more light sources than the light module 104. In general, attaching the electronics housing 102 and the light module 104 to opposite ends of the tubular connector 106 produces the lighting fixture 100 of FIG. 1, and attaching the electronics housing 102 and the light module 902 to opposite ends of the tubular connector 106 produces the lighting fixture 900 of FIG. 9.

To illustrate, a lighting fixture such as the lighting fixtures 100, 900 may be assembled by selecting from among multiple electronics housings and from among multiple light modules and attaching the selected housing and light module to the tubular connector 106. After the selected electronics housing and light module are attached to the tubular connector 106, an electrical cable, such as the electrical cable 408, may be routed between the electronics housing and the light module that includes light sources. In some alternative embodiments, an electrical cable that includes multiple electrical wires may be connected to the selected light module before the selected light module is attached to the tubular connector 106, and the electrical cable may be routed through the tubular connector 106 before the light module is attached to the light module. One or more drivers may be placed in the selected electronics housing before or after the electronics housing is attached to the tubular connector 106.

In some example embodiments, the light module 902 may include light sources, such as a light source 1002 that includes LEDs 1004, that are attached to PCBs. For example, the light module 902 may include eight light sources. In some alternative embodiments, the light module 902 may include more or fewer light sources without departing from the scope of this disclosure. The light sources, such as the light source 1002, may be powered by one or more drivers, such as the driver 402 shown in FIG. 4, via an electrical cable (e.g., the electrical cable 408) in the same manner as described above with respect to the lighting fixture 100 of FIG. 1.

In some example embodiments, the lighting fixture 900 may include lenses, such as a lens 1006, that may be secured to the heat sink 904 by brackets, such as brackets 1008, 1010. The lenses may cover the light sources and provide protection against water and dust.

In some example embodiments, the lighting fixture 900 may include a sensor 1012 that may be attached to a cover 1014. For example, the cover 1014 may be attached to the heat sink 904 by fasteners, and the sensor 1012 may be positioned in an opening of the cover 1014. The sensor 1012 may be an occupancy sensor, a light sensor, etc. that may be used to control the operation of the light module 902.

In some alternative embodiments, the sensor 1012 may be omitted without departing from the scope of this disclosure. In some alternative embodiments, some components of the lighting fixture 900 may have a different shape than shown without departing from the scope of this disclosure. In some alternative embodiments, the lenses may be secured to the heat sink 904 using other means than brackets without departing from the scope of this disclosure.

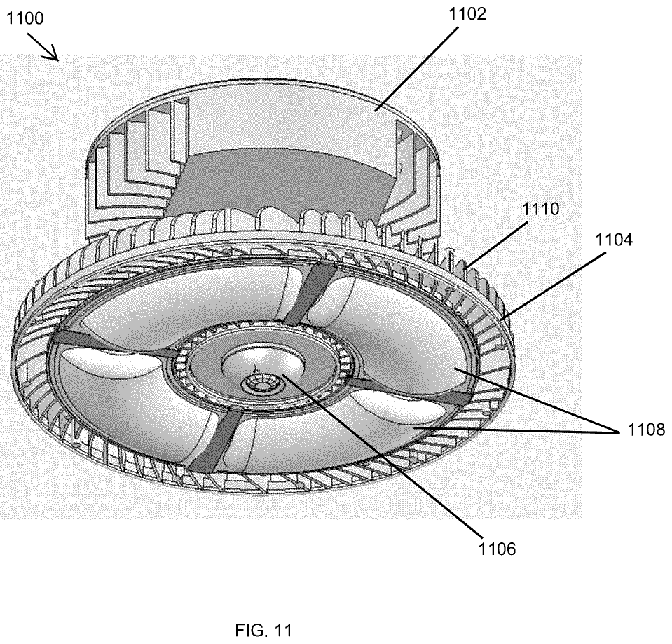

FIG. 11 is a bottom perspective view of a high bay lighting fixture 1100 according to another example embodiment. In some example embodiments, the lighting fixture 1100 is substantially similar to the lighting fixture 100. For example, the lighting fixture 1100 may include an electronics housing 1102, a light module 1104, and lenses 1108 that may respectively correspond to the electronics housing 102, the light module 104, and the lenses of the lighting fixture 100. The lighting fixture 1100 may also include a tubular connector, such as the tubular connector 106 of the lighting fixture 100, that is connected to a heat sink 1110 of the light module 1104. Alternatively, the lighting fixture 1100 may include multiple tubular connectors that extend between the electronics housing 1102 and the light module 1104.

In some example embodiments, the light module 1104 may include light sources, such as the light source 112, 114 of the lighting fixture 100, that are powered by a driver, such as the driver 402 shown in FIG. 4, positioned in the electronics housing 1102 in a similar manner as described above with respect to the lighting fixture 100. The light sources may be attached to the heat sink 1104 on the side of the heat sink facing away from the electronics housing 1102, where the heat sink dissipate heat from the light sources. The separation between the light module 1104 and the heat sink 1110 provided by the one or more tubular connectors reduces the impact of heat dissipated by the heat sink 1110 on the electronic component inside the electronics housing 1102. The separation between the light module 1104 and the heat sink 1110 also reduces the impact of heat dissipated by electronics components in the electronics housing 1102 on the light sources of the light module 1104.

In some example embodiments, the lighting fixture 1100 may include a sensor 1106. For example, the sensor 1106 may be an occupancy sensor, a light sensor, etc., where the light sources of the light module 1104 may be controlled based on sensing by the sensor 1106.

In some example embodiments, the sensor 1106 may be connected to a power source, such as the driver 402 shown in FIG. 4, positioned in the electronics housing 1102. To illustrate, the sensor 1106 may be connected to the power source via an electrical cable, such as the electrical cable 408 shown in FIG. 4. The power source may provide power to the sensor 1106 via the electrical cable. The sensor 1106 may provide a detection status indicator to the driver or to another component in the electronics housing 1102 via an electrical cable.

In some alternative embodiments, the sensor 1106 may be omitted without departing from the scope of this disclosure. In some alternative embodiments, the lighting fixture 1100 may include a different electronics housing and/or light module than shown without departing from the scope of this disclosure. For example, the electronics housing 1102 may be replaced by the electronics housing 102 of the lighting fixture 100 without departing from the scope of this disclosure.

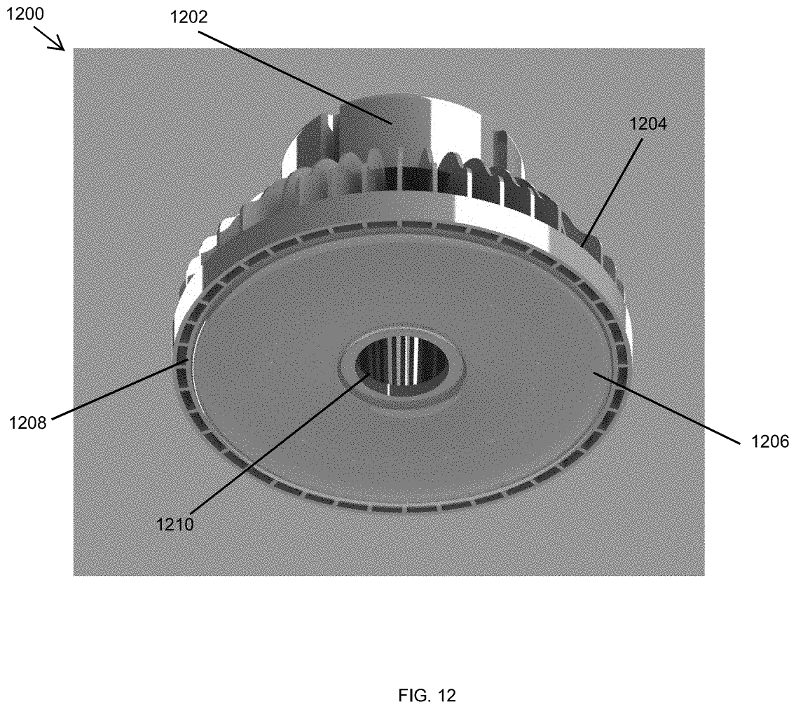

FIG. 12 is a bottom perspective view of a high bay lighting fixture 1200 according to another example embodiment. In some example embodiments, the lighting fixture 1200 includes an electronics housing 1202 and a light module 1204. The light module 1204 may include a light source 1206 that is attached to a heat sink 1208. For example, the heat sink 1208 may correspond to the heat sink 110 shown in FIG. 1.

In some example embodiments, the light source 126 may include LEDs and one or more lenses covering the LEDs, where the LEDs are attached to one or more PCBs. The PCBs may be attached to the heat sink 1208 such that heat generated by the light source 1206 may be dissipated by the heat sink 1208. The one or more lenses may provide to the LEDs and the PCBs a protection against water and dust.

In some example embodiments, one or more drivers may be positioned the electronics housing 1202. For example, the driver 402 shown in FIG. 4 with respect to the lighting fixture 100 may be positioned in the electronics housing 1202. An electrical cable, such as the electrical cable 408 shown in FIG. 4, may be routed from the driver in the electronics housing 1202 to the light source 1206. For example, the electronics housing 1202 may be directly attached to the heat sink 1208, and one or more wires of the electrical cable may be routed at the back side of the heat sink or through wireways in the heat sink 1208 in a similar manner as described with respect to the electrical cable 408 shown in FIG. 4.

In some example embodiments, the light source 1206 may include an opening 1210 that is aligned with an opening in the heat sink 1208. For example, a sensor (e.g., the sensor 1106 shown in FIG. 11) may be positioned in the opening 1210 and may be used to control the light source 1206. Alternatively, the sensor may be omitted, and the opening 1210 may be closed off, for example, by a removable cover.

In some alternative embodiments, the lighting fixture 1200 may include a different electronics housing and/or light module than shown without departing from the scope of this disclosure. In some alternative embodiments, the electronics housing 1202 and/or the light module 1204 may have a different shape than shown without departing from the scope of this disclosure.

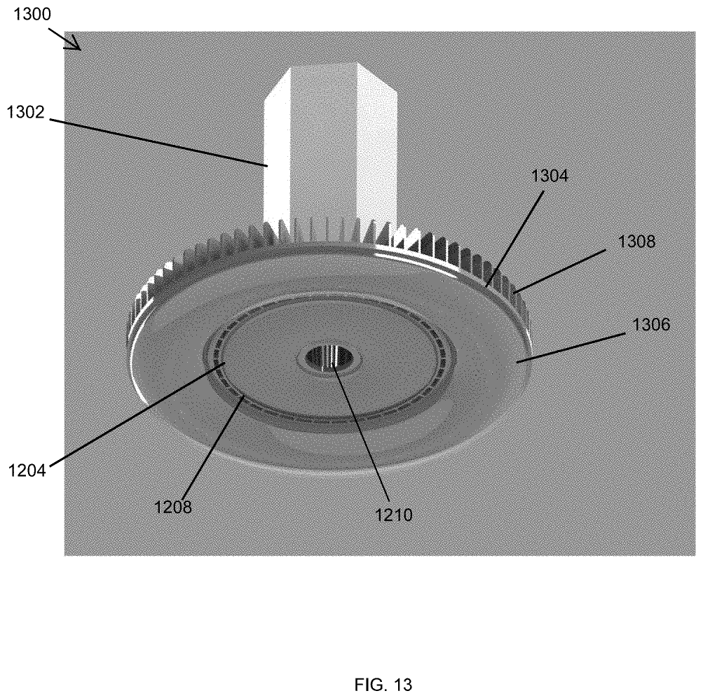

FIG. 13 is a bottom perspective view of a high bay lighting fixture 1300 according to another example embodiment. Referring to FIGS. 12 and 13, in some example embodiments, the lighting fixture 1300 includes an electronics housing 1302, a light module 1304 (i.e., a secondary light module) that is positioned at the outer perimeter of the light module 1204 (i.e., the primary light module) of FIG. 12. The light module 1304 may include a light source 1306 and a heat sink 1308, where the light source 1306 is attached to the heat sink 1308. The light source 1306 may include LEDs that are covered by lenses in a similar manner as described above. One or more drivers (e.g., one or more of the driver 402 shown in FIG. 4) may be positioned in the electronics housing 1302 and may provide power to the light sources of the light modules 1204, 1304.

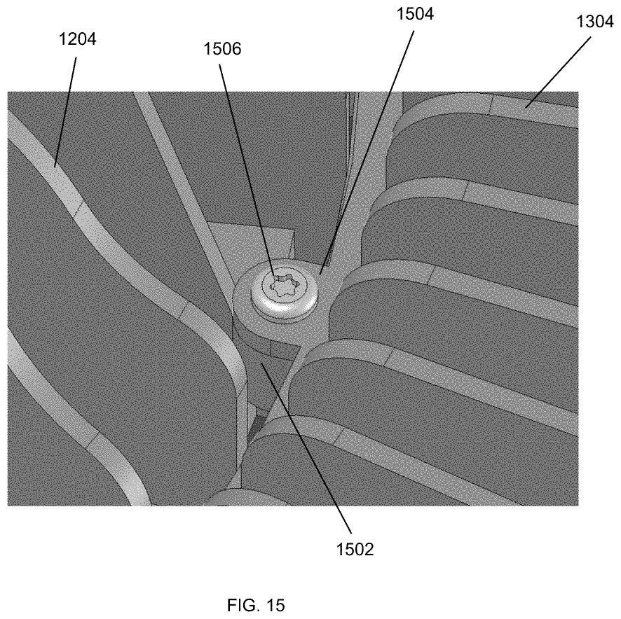

In some example embodiments, the heat sink 1308 may be attached to the heat sink 1208 of the light module 1204 using fasteners, clips, hooks, and/or other means as may be contemplated by those of ordinary skill in the art with the benefit of this disclosure. For example, the heat sink 1308 may be attached to the heat sink 1208 using one or more fasteners in a manner shown in FIG. 15. The attachment of the heat sink 1308 to the heat sink 1208 may result in the light module 1304 being securely attached to the light module 1204. An electrical cable may be routed from one or more drivers in the electronics housing 1302 to the light module 1204 as described above, and the electrical wires may be extended to the light sources of the light module 1304, for example, at the back side of the light module 1204 or through wireways in the heat sink 1208. The combination of the light module 1204 and the light module 1304 may provide a light with an increased (midrange) lumen level compared to the lumen level of the light provided by the lighting fixture 1200 that does not include the light module 1304.

In some alternative embodiments, the lighting fixture 1300 may include a sensor, such as the sensor 1106, without departing from the scope of this disclosure. For example, the sensor may be positioned in the opening 1210 as described above. Alternatively, the opening 1210 may be closed off. In some alternative embodiments, the electronics housing 1302 and/or the light module 1304 may have a different shape than shown without departing from the scope of this disclosure.

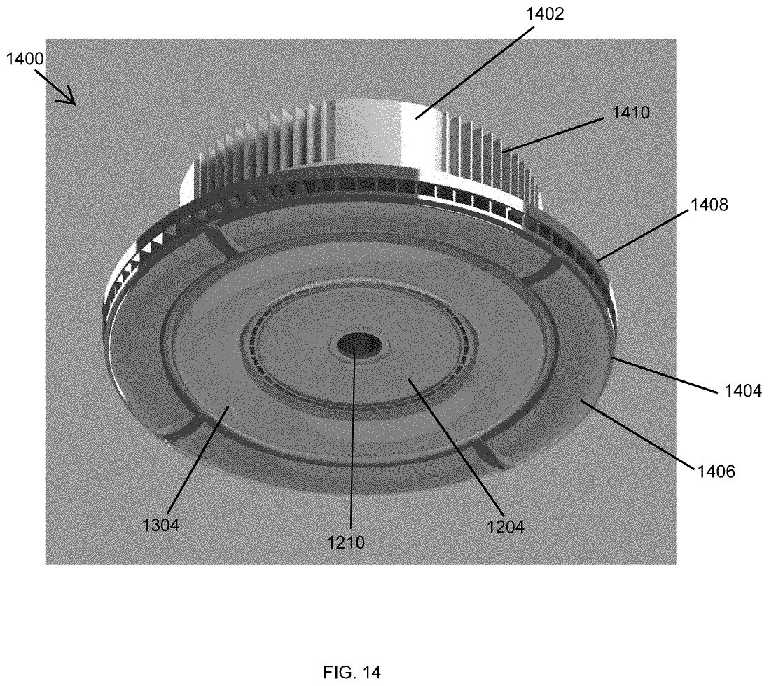

FIG. 14 is a bottom perspective view of a high bay lighting fixture according to another example embodiment. Referring to FIGS. 12-14, in some example embodiments, the lighting fixture 1400 includes an electronics housing 1402 and a light module 1404 (i.e., a tertiary light module) that is positioned at the outer perimeter of the light module 1304 (i.e., the secondary light module) shown in FIG. 13. In the lighting fixture 1400, the light module 1304 is positioned at the outer perimeter of the light module 1204 shown in FIG. 12. The light module 1404 may include a light source 1406 and a heat sink 1408, where the light source 1406 is attached to the heat sink 1408. The light source 1406 may include LEDs that are covered by lenses in a similar manner as described above. One or more drivers (e.g., one or more of the driver 402 shown in FIG. 4) may be positioned in the electronics housing 1402 and may provide power to the light sources of the light modules 1204, 1304, 1404 via an electrical cable similar to the electrical cable 408 shown in FIG. 4.

In some example embodiments, the heat sink 1308 may be attached to the heat sink 1208 of the light module 1204 using fasteners, clips, hooks, and/or other means as may be contemplated by those of ordinary skill in the art with the benefit of this disclosure. For example, the heat sink 1308 may be attached to the heat sink 1208 using one or more fasteners in a manner shown in FIG. 15. The attachment of the heat sink 1308 to the heat sink 1208 may result in the light module 1304 being securely attached to the light module 1204. An electrical cable similar to the electrical cable 408 shown in FIG. 4 may be routed to the light module 1204 as described above, and the electrical wires of the electrical cable 408 may be extended to the light sources of the light module 1304, for example, at the back side of the light module 1204 or through the wireways in the heat sink 1208 in a similar manner as described with respect to the lighting fixture 1300. When the light module 1204 and the light module 1304 are both powered on, the lighting fixture 1400 may provide a light with an increased (midrange) lumen level compared to the lumen level of the light provided by the lighting fixture 1200 that does not include the light module 1304.

In some example embodiments, the heat sink 1408 may be attached to the heat sink 1308 of the light module 1304 using fasteners, clips, hooks, and/or other means as may be contemplated by those of ordinary skill in the art with the benefit of this disclosure. For example, the heat sink 1408 may be attached to the heat sink 1308 using one or more fasteners in a similar manner as shown in FIG. 15. The attachment of the heat sink 1408 to the heat sink 1308 may result in the light module 1404 being securely attached to the light module 1304. Electrical wires that are routed to the light module 1304 may be extended to the light sources of the light module 1404, for example, at the back side of the light module 1304 or through the wireways in the heat sink 1308. When the light modules 1204, 1302, 1404 are all powered on, the lighting fixture 1400 may provide a light with an increased (high range) lumen level compared to the lumen levels of the lights provided by the lighting fixtures 1200, 1300 individually.

In some example embodiments, the light modules 1204, 1304, 1404 may be ring-shaped as shown in FIGS. 12-14, where the light module 1204 fits within the light module 1304 and where the light module 1304 fits within the light module 1404. In some alternative embodiments, the light modules 1204, 1304, 1404 may have a different shape without departing from the scope of this disclosure. In some example embodiments, the light module 1304 and the light module 1404 may be added to the light module 1204 at the factory/assembly plant based on the need for a particular lumen output of a lighting fixture.

FIG. 15 is closeup view of an attachment mechanism of light modules of the high bay lighting fixture of FIGS. 13 and 15 according to another example embodiment. Referring to FIGS. 12-15, in some example embodiments, the heat sink 1208 of the light module 1204 of FIG. 12 may have one or more lugs, such as a lug 1502, with a respective threaded hole, and the heat sink 1308 of the light module 1304 of FIG. 13 may have corresponding one or more flanges, such as a flange 1504, with a respective hole. A screw may be inserted through the hole in each flange and may be screwed into the respective hole of each respective lug, thereby securely attaching the light module 1304 to the light module 1204. To illustrate, a screw 1506 may be screwed into the hole in the lug 1502 through the hole in the flange 1504.

In some example embodiments, the heat sink 1408 of the light module 1402 of FIG. 14 may be to the heat sink 1308 in a similar manner. To illustrate, the heat sink 1308 may include flanges on its inner perimeter for attachment to the heat sink 1208, and the heat sink 1408 may include flanges on its inner perimeter for attachment to the heat sink 1308. In general, multiple lugs and/or flanges may be located around the respective perimeters of the heat sinks 1204, 1304, and 1408.

In some alternative embodiments, the lug 1502 and the flange 1504 may have different shapes than shown without departing from the scope of this disclosure. In some alternative embodiments, the lug 1502 and the flange 1504 may be located at a different location than shown without departing from the scope of this disclosure.

Although particular embodiments have been described herein in detail, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the spirit and scope of the following claims, the scope of which are to be accorded the broadest interpretation so as to encompass modifications and equivalent structures.

What is claimed is:

1. A high bay lighting fixture, comprising:
an electronics housing;
a light module comprising a light source that emits a light; and
a tubular connector, wherein the electronics housing is attached to the tubular connector at a first end of the tubular connector, wherein the light module is attached to the tubular connector at a second end of the tubular connector separated from the electronics housing by the tubular connector, wherein the tubular connector provides a wireway for routing an electrical wire between the electronics housing and the light module.

2. The high bay lighting fixture of claim 1, wherein the light module comprises a heat sink, wherein the light source is attached to the heat sink on a side of the heat sink facing away from the electronics housing, and wherein the heat sink is positioned to dissipate heat generated by the light source.

3. The high bay lighting fixture of claim 2, wherein the heat sink comprises fins on a second side of the heat sink facing toward the electronics housing.

4. The high bay lighting fixture of claim 2, further comprising one or more lenses covering the light source.

5. The high bay lighting fixture of claim 2, wherein the electrical wire is routed to the light source through one or more holes in an inner frame of the heat sink, wherein the light source is positioned between the inner frame and an outframe of the heat sink.

6. The high bay lighting fixture of claim 1, further comprising a driver positioned in the electronics housing, where the driver is configured to provide an electrical power to the light source via the electrical wire.

7. The high bay lighting fixture of claim 1, wherein the electronics housing comprises a side door designed to be rotatably opened sideways to provide access to a cavity of the electronics housing.

8. The high bay lighting fixture of claim 7, wherein the side door comprises fins positioned to dissipate heat from the electronics housing.

9. The high bay lighting fixture of claim 1, further comprising a sensor attached to the light module.

10. A high bay lighting fixture component assembly, comprising:
an electronics housing;
a light module comprising a light source that emits a light; and
a tubular connector, wherein the electronics housing is one of multiple electronics housings that are designed for attachment to the tubular connector at a first end of the tubular connector, wherein the light module is one of multiple light modules that are designed for attachment to the tubular connector at a second end of the tubular connector, and wherein each light module of the multiple light modules is configured to emit a light having lumens output that is different from the lumens output of lights emitted by other light modules of the multiple light modules.

11. The high bay lighting fixture assembly of claim 10, wherein the tubular connector provides a separation between the electronics housing and the light module.

12. The high bay lighting fixture assembly of claim 10, wherein the tubular connector provides a wireway for routing an electrical wire between the electronics housing and the light module.

13. The high bay lighting fixture assembly of claim 10, wherein the light module comprises a heat sink having fins on a first side of the heat sink, wherein the light source is attached to the heat sink on a second side of the heat sink, and wherein the heat sink is positioned to dissipate heat generated by the light source.

14. The high bay lighting fixture assembly of claim 10, further comprising one or more lenses covering the light source.

15. The high bay lighting fixture assembly of claim 10, further comprising a driver positioned in the electronics housing, where the driver is configured to provide an electrical power to the light source via the electrical wire.

16. The high bay lighting fixture assembly of claim 10, further comprising a sensor attached to the light module.

17. A method of assembling a suspended lighting fixture, comprising:
providing a tubular connector;
attaching an electronics housing to a first end portion of the tubular connector, wherein the electronics housing is one of multiple electronics housings that are designed for attachment to the first end portion of the tubular connector; and
attaching a light module to a second end portion of the tubular connector, wherein the light module is one of multiple light modules that are designed for attachment to the second end portion of the tubular connector, wherein the tubular connector provides a separation between the electronics housing and the light module.

18. The method of claim 17, wherein the light module comprises a heat sink having fins on a first side of the heat sink, wherein the light source is attached to the heat sink on a second side of the heat sink, and wherein the heat sink is positioned to dissipate heat generated by the light source.

19. The method of claim 17, further comprising attaching a sensor to the light module.

20. The method of claim 17, further comprising routing an electrical wire between the electronics housing and the light module through the tubular connector.
